(19) United States
(12) Patent Application Publication
(10) Pub. No.: US 2024/0234754 A1
(43) Pub. Date: Jul. 11, 2024

(54) DIRECT AND HOMOGENEOUS INTERNAL REFORMING SOLID OXIDE FUEL CELL SYSTEM

(71) Applicant: KARADENIZ TEKNIK ÜNIVERSITESI TEKNOLOJI TRANSFERI UYGULAMA VE ARASTIRMA MERKEZI, Trabzon (TR)

(72) Inventor: Özgür AYDIN, Trabzon (TR)

(21) Appl. No.: 18/000,490

(22) PCT Filed: Dec. 29, 2021
(86) PCT No.: PCT/TR2021/051601

§ 371 Date: Dec. 1, 2022

(30) Foreign Application Priority Data
Nov. 25, 2021 (TR) 2021/018503

(51) Int. Cl. H01M 8/0276; H01M 8/04082; H01M 8/0637; H01M 8/12; H01M 8/1213

(52) U.S. Cl. CPC H01M 8/0276; H01M 8/04201; H01M 8/0637; H01M 8/1213; H01M 2008/1293

(57) ABSTRACT

Disclosed is a solid oxide fuel cell system with a direct internal reformer that can separate the DIR and EHO reactions and keep the DIR rate constant throughout the flow. The system contains a fuel pipe, a head flange, a DIR tube, an EHO tube, a DIR end flange, a last flange, a DIR exhaust pipe, an EHO exhaust pipe, connecting bolts, and ceramic paste so as to fulfill this.

### FIELD OF THE INVENTION

The present invention relates to a solid oxide fuel cell system with direct internal reformer that can both keep the DIR rate constant throughout the flow and stabilize the current generation in the EHO zone by separating the DIR and EHO reactions.

### STATE OF THE ART

Solid Oxide Fuel Cell (SOFC) is a type of electrochemical energy converter. It preferably converts the internal energy of hydrogen into electricity through Electrochemical Hydrogen Oxidation Reaction (EHO).

$${H}_{2} + 1 / 2 ⇌ {H}_{2} O$$

$$Δ {H}^{298 K} = - 241.8 kJ / mol$$

Hydrogen can either be extracted from water by electrolysis (utilization of electrical energy), or from hydrocarbons (e.g. methane, propane, etc.) in Catalytic Steam Reformers (CSRs). Due to the challenges associated with the storage and transport of hydrogen, i.e. the insufficient infrastructure, it is demanded that hydrogen should be “on-site” produced from methane, as methane has a well-developed distribution infrastructure worldwide and it is currently the main source of hydrogen.

Basically hydrogen is produced in a CSR via Methane Steam Reforming (MSR) and Water Gas Shift (WGS) reactions (they will be hereafter referred to as DIR reactions) by supplying heat and water from external sources.

$$MSR : {CH}_{4} + {H}_{2} O ⇌ CO + 3 {H}_{2}$$

$$Δ {H}^{298 K} = + 206 kJ / mol$$

$$WGS : CO + {H}_{2} O ⇌ {CO}_{2} + {H}_{2}$$

$$Δ {H}^{298 K} = - 41 kJ / mol$$

An interesting fact is that CSRs and SOFCs operate at similar temperatures (700° C.-) and they employ the same catalysts [1-6]. These common features have been inspiring researchers for producing hydrogen in SOFCs. The simultaneous progress of hydrogen production and consumption in the SOFC anode is called Direct Internal Reforming (DIR), which offers several advantages [1-6]
It eliminates CSRs and peripheral components required for heat and water supply; hence it reduces the capital and maintenance cost significantly.
It allows for using the waste heat and water produced by the EHO reaction; thus it elevates the system efficiency while reducing the operating cost remarkably.
It cools down SOFCs, so that fans and the power they consume are eliminated. Therefore, the capital, maintenance as well as the operating costs drop considerably.
It can prevent fuel dilution by consuming the water on-site produced, so that the decrease in the equilibrium potential of the SOFC and the respective drop in the electrical power can be eliminated.

In summary, DIR simplifies the SOFC system and it reduces the initial, operating, and maintenance costs remarkably. However, there are two big problems associated with the DIR process which are explained in the following.

The most crucial problem in DIR-SOFCs is the unstable power supply. There is a competition between the DIR and EHO reactions, as they both proceed over the same catalyst in the SOFC anode [6]. This competition gives rise to an unstable current generation which becomes worse with increasing water concentration [6]. On the other hand, water must be fed externally along with methane as the reforming agent for the DIR reactions to proceed without carbon deposition [7,8]. When the water produced by the EHO reaction is added, the water concentration in the EHO domain becomes rather high, so that current generation becomes much more unstable. Considering these facts, it can be deduced that
The DIR and EHO reactions must be separated for DIR-SOFCs to generate electrical power stably.
Methane and the reforming agent water must be prevented from entering the EHO domain.

The second problem is associated with the rate of the DIR reactions, which are extremely high in the fuel upstream of DIR-SOFCs, whereas they drop quickly toward the downstream [3,4]. Due to the strong endothermic characteristic of the MSR reaction, an extreme cooling occurs in the fuel upstream, which results in thermal stresses on the fragile SOFC components. It is well-known that thermal stresses are the most serious threat to the mechanical durability of SOFCs [9-14]. Furthermore, it is speculated that the endothermic cooling may prompt carbon deposition, which reportedly deactivates the catalysts and blocks the pores within the anode microstructure [15]. Therefore, a uniform DIR rate must be accomplished along the flow field through kinetic and thermodynamic considerations.

There have been diverse inventions for resolving the aforementioned problems, which may be categorized as “Catalyzed Interconnect”, “Allocated Active Area”, and “Separate Domains” due to their common features.

The following applications are found in the literature; document numbered U.S. Pat. No. 5,496,655 titled “Catalytic bipolar interconnection plate for use in a fuel cell”, document numbered U.S. Pat. No. 5,660,941 titled “Catalyst assembly for internal reforming fuel cell”, document numbered U.S. Pat. No. 7,732,084 B2 titled “Solid oxide fuel cell with internal reforming, catalyzed interconnect for use therewith, and methods”, document numbered US 2002/0197518 A1 titled “Corrugated current collector for direct internal reforming fuel cells,” and document numbered US 2005/0053819 A1 titled “Solid oxide fuel cell interconnect with catalyst coating” that can be categorized under the group of “Gas Distribution Plate with Catalyst” [17-21].

The method of catalyzed interconnect aims to create another catalytic domain on the already existing current collector (interconnect) of the SOFC for the DIR reactions (in addition to the porous anode), so that it could alleviate the competition between the reactions. However, this method is considered disadvantageous from the following aspects:
It does not address the drastic drop in the DIR rate and carbon deposition at all.
It cannot completely resolve the current instability, as the catalyzed current collector does not inhibit methane and water entering the anode of SOFC. In other words, this method cannot guarantee that the DIR reactions will proceed over the catalyzed interconnect.

In summary, this method cannot address any of the problems associated with DIR-SOFCs.

The following applications are found in the literature; document numbered U.S. Pat. No. 4,647,516 titled “Internal reform type fuel cell”, document numbered U.S. Pat. No. 4,788,110 titled “Fuel cell with partially shielded internal converter”, document numbered U.S. Pat. No. 7,547,484 B2 titled “Solid oxide fuel cell tube with internal fuel processing,” and document numbered U.S. Pat. No. 8,216,738 B2 entitled “Deactivation of SOFC anode substrate for direct internal reforming” that can be categorized under the group “Shared Active Space” [22-25].

This type of inventions aims at reserving a part of the active EHO area for the DIR process. Although the regarding inventions basically reform hydrocarbons prior to entering the EHO zone, preventing the competition between the reactions, the following points are considered as drawbacks:
It reduces the active EHO area, as a part of the volume is reserved for the DIR reactions.
It causes dramatic temperature difference between the allocated zones, as the heat supplying domain (EHO) comes after the heat consuming domain (DIR).

In summary, this method cannot ensure a homogeneous temperature distribution over the fragile SOFC components.

The following applications are found in the literature; document numbered U.S. Pat. No. 4,182,795 titled “Fuel cell thermal control and reforming of process gas hydrocarbons”, document numbered 4,365,007 titled “Fuel cell with internal reforming”, document numbered U.S. Pat. No. 4,567,117 titled “Fuel cell employing non-uniform catalyst”, document numbered U.S. Pat. No. 4,877,693 titled “Fuel cell apparatus for internal reforming,” and document numbered U.S. Pat. No. 5,082,751 titled “Internal natural gas reformer-dividers for a solid oxide fuel cell generator configuration” that can be categorized under the group of “Separated Reaction Zones”[26-30].

The other type of inventions aims to provide separate domains for the DIR and EHO reactions without reducing the active EHO area. However, it is thought that this invention brings the following disadvantages along:
It requires complex modifications on the regarding components e.g., non-uniform perforation of the DIR domain, non-uniform distribution of the catalysts in the DIR domain, etc. for establishing a uniform temperature distribution in order to prevent thermal stresses.
It cannot prevent methane and water diffusion into the EHO domain, so that it cannot resolve the current instability.

In summary, this method of inventions cannot resolve the problem of unstable power generation associated with DIR-SOFCs.

For realizing DIR-SOFCs, separating the DIR and EHO reactions and establishing a uniform DIR rate along the flow field is necessary. As summarized in preceding section, none of the previous inventions was able to meet these requirements together. To make DIR-SOFCs work, the current invention attempts to address the radically falling DIR rate as well as the current instability at a significantly lower complexity and cost.

As a crucial term in fuel cells, the fuel utilization rate (Uf), refers to the ratio of the fuel consumed (H₂ⁱⁿ−H₂^{out}[ccm/min]) to the total fuel supplied (H₂ⁱⁿ[ccm/min]) to the system.

$${U}_{f} = \frac{{H}_{2}^{in} - {H}_{2}^{out}}{{H}_{2}^{in}}$$

From the aspect of operating cost, the higher the fuel utilization rate the better. This means that the inlet fuel supply is conventionally kept minimum for maximizing the fuel utilization rate.

In basic DIR-SOFCs, the DIR reactions are kinetically as well as thermodynamically favored owing to the high activity of the catalyst and the elevated operating temperatures. When a DIR-SOFC is operated at a usual fuel utilization rate, most of the methane (˜90%) is consumed in the upstream [3,4], producing sufficient hydrogen for the whole EHO domain. This means that the DIR rate radically decreases in the upstream. Since methane yields four moles of hydrogen (MSR and WGS reactions), it may be said that one-quarter of the active EHO area in the anode upstream suffices for generating electrical current throughout the whole active EHO area. Having that the DIR process is strongly endothermic, the amount of heat consumed attains the severest degree in the fuel upstream, leading to an extreme local cooling [3]. As a result, thermal stresses develop, prompting crack formation in the SOFC and possibly leading to carbon deposition over the catalyst particles. In conclusion, the drastically decaying DIR rate is attributed to the limited fuel supply (maximum fuel utilization rate), which inspired us to invent the concept illustrated and explained in the following.

### BRIEF DESCRIPTION OF THE INVENTION

The present invention relates to a method that can solve both of the above-described problems of DIR-SOFC and simplify both the manufacture and operation of these systems.

The main aim of the invention is to develop a DIR-SOFC system that maximizes the DIR rate and ensures that all hydrogen produced is used at the full capacity in the EHO tube.

An aim of the invention is to develop a DIR-SOFC system that ensures homogeneous distributions of the DIR rate and temperature throughout, so that the carbon deposition will be prevented.

A similar aim of the invention is to develop a DIR-SOFC system that ensures that all the hydrogen produced in the DIR tube is completely consumed in the EHO tube by using the diameter of the EHO tube, so that a good supply-demand balance is established between the DIR and EHO tubes and the thermodynamic limitations affecting the DIR rate are lifted.

Another aim of the invention is to develop a cost-effective DIR-SOFC system by facilitating its design and manufacture.

The invented DIR-SOFC system contains fuel inlet pipe, main flange, DIR tube, EHO tube, DIR end flange, last flange, DIR exhaust pipe, EHO exhaust pipe, connecting bolts, ceramic paste, anode current and voltage wires and cathode current and voltage wires.

The structural and characteristic features of the present invention will be understood clearly by the following drawings and the detailed description made with reference to these drawings and therefore the evaluation shall be made by taking these figures and the detailed description into consideration.

### FIGURES CLARIFYING THE INVENTION

FIG. 1. The operating principle of the invention

FIG. 2. Schematic of the invention

FIG. 3. Perspective view of the invention

FIG. 4. Perspective view of the invention

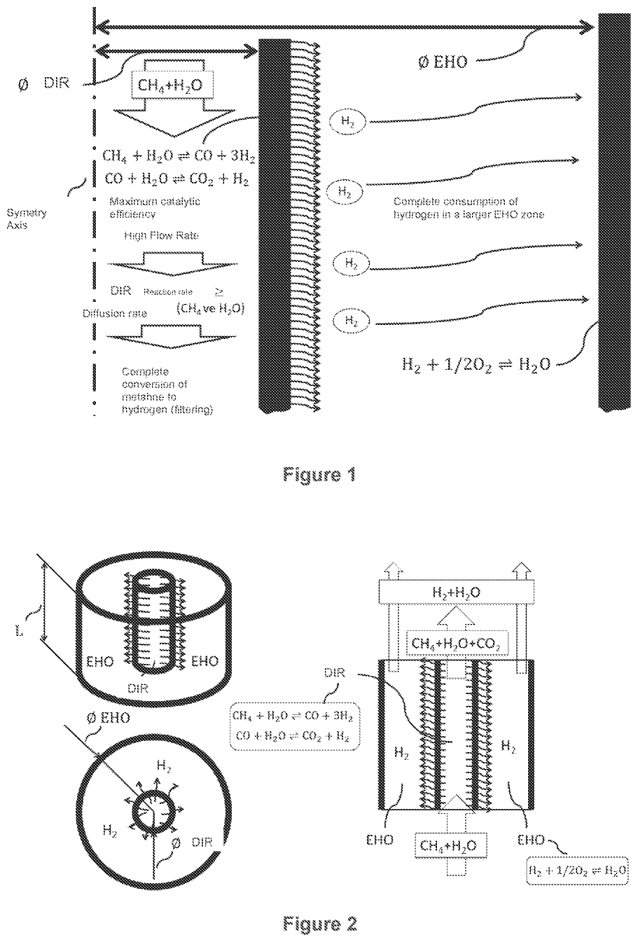

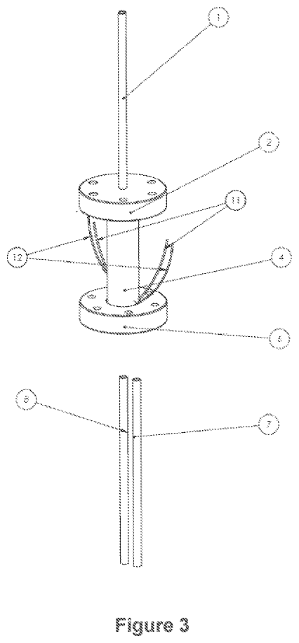

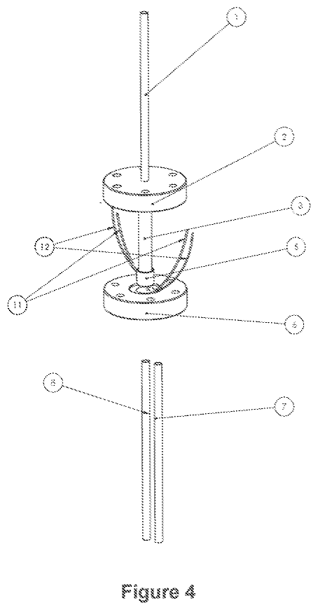

### DESCRIPTION OF THE REFERENCES

1 Fuel inlet pipe
2 Main flange
3 DIR tube
4 EHO tube
5 DIR end flange
6 Last flange
7 DIR exhaust pipe
8 EHO exhaust pipe
9 Connecting bolts
10 Ceramic paste (possible)
11 Anode current and voltage wires
12 Cathode current and voltage wires

### DETAILED DESCRIPTION OF THE INVENTION

EHO tube (4) and DIR tube (3) are the main components of DIR-SOFC. The EHO tube (4) functions as a SOFC; it generates electrical energy by using the hydrogen produced in the DIR tube (3). Although the EHO tube (4) basically consists of three layers as anode, cathode and electrolyte, it may also have a support element. In addition, it may have functional layers of anode and cathode. The diameter of the EHO tube must be larger than the diameter of the DIR tube (3) so as to use all the hydrogen produced in the DIR tube (3). The DIR tube (3) acts as a catalytic reactor; it converts methane into hydrogen by using the waste heat released in the EHO tube (4). While the DIR tube (3) allows the diffusion of hydrogen towards the EHO tube (4), it must have a special microstructure that restricts the diffusion of methane and water. The fuel mixture is delivered to the DIR tube (3) through the fuel inlet pipe (1). The fuel inlet flow rate must be kept at an amount so as to ensure that the DIR rate is constant along the DIR tube (3). The reaction products released in the DIR tube (3) leave the system through the DIR exhaust pipe (7), and the reaction products released in the EHO tube (4) leave the system through the EHO exhaust pipe (8). EHO exhaust pipe (8) and DIR exhaust pipe (7) must be manufactured from high temperature resistant materials. Main flange (2), DIR end flange (5), last flange (6) and connecting bolts (9) hold DIR-SOFC components together and they protect these components against pulling, pushing, bending and torsion forces. Flanges are designed according to the dimensions of DIR (3) and EHO (4) tubes and must be made of materials that can operate at high temperatures. On the other hand, ceramic paste (10) applied to both ends of DIR and EHO tubes (3, 4) is a sealing material that separate the DIR and EHO zones and keep the gases in the zones where they must be. The anode current and voltage wires (11) and the cathode current and voltage wires (12) are responsible for electron transfer between the anode and cathode, they must be produced from materials with high electrical conductivity and high temperature resistance.

In this invention, there are two different domains (tubes) for the DIR and EHO reactions to proceed separated from each other. Since the diffusion coefficients of methane and

water are much smaller than that of hydrogen [16], and the diffusion pathway (the wall thickness of the DIR tube) can be designed/controlled appropriately, methane and water could be filtered out through the DIR tube. In this way, the disturbance on the current generation in the EHO domain due to the DIR reactions and the extreme water concentration can be minimized. From this aspect, the current invention resolves the current instability problem.

As to the endothermic cooling problem, this invention removes the limit put on the inlet fuel supply for achieving a high fuel utilization rate and it considers supplying methane at the maximum flow rate for making use of the available DIR domain [4]. The purpose is to make all the DIR tube convert methane to hydrogen at the same rate, so that there will not be any difference in the amount of heat consumed and the temperature variations will be minor along the DIR as well as EHO tube. This enhances the system efficiency as the whole DIR domain utilizes the waste heat for reforming methane to hydrogen which is utilized for on-site power generation.

It should be noted that the amount of hydrogen utilized in the EHO tube changes depending on the operating SOFC voltage. Even if the SOFC operating voltage can change, there is fact that durability of SOFCs is highly sensitive to the operating voltage [31]. Thus, SOFCs are usually operated around 0.7 V to prevent microstructure degradation. This can be interpreted in a way that the hydrogen consumption rate in SOFCs can be considered as dependent on the dimension (the active area).

As one mole of methane yields four moles of hydrogen, the total hydrogen produced within the DIR domain might be much more than what is needed for power generation in the EHO tube if the EHO tube is adjacent (identical diameter) to the DIR tube. However, utilization of hydrogen released in the DIR tube can be maximized by enlarging the active area in the EHO tube for which the diameter of the tube can be used.

In summary, the current invention leans upon maximizing the reforming rate in the DIR tube and utilizing the produced hydrogen at the full capacity in the EHO tube by setting the diameter of the tube appropriately. As the DIR tube converts methane to hydrogen at the full capacity under optimum reforming conditions, the high quality waste heat be utilized at maximum. Besides, the DIR reactions are distributed along the flow field, minimizing the temperature gradients and carbon deposition. All the produced hydrogen is utilized in the EHO tube based on geometric proportionality. In this way, a good demand-supply balance between the EHO and DIR tubes is established, so that thermodynamic limitations are removed.

### REFERENCES

[1] P. Aguiar, C. S. Adjiman, and N. P. Brandon, “Anode-supported intermediate temperature direct internal reforming solid oxide fuel cell. I: model-based steadystate performance,” J. Power Sources, 138, 120-136 (2004).
[2] H. Timmerman, D. Fouquet, A. Weber, E. Ivers-Tiffee, U. Hennings, and R. Reimert, “Internal reforming of methane at Ni/YSZ and Ni/CGO SOFC cermet,” Fuel Cells, 06 (3-4), 307-313 (2006)
[3] J. E. A. Saunders and M. H. Davy, “In-situ studies of gas phase composition and anode surface temperature through a model DIR-SOFC steam-methane converter at 973.15K,” Int. J. Hydrogen Energy, 38, 13762-13773 (2013).
[4] H. Muroyama, D. Ando, T. Okanishi, T, Matsui, and K. Eguchi, “Gas composition analysis on Ni-YSZ anode in direct internal reforming solid oxide fuel cell,” ECS Trans., 68, 1151-1160 (2015).
[5] H.- T. Lim, C. Yang, S. C. Hwang, and Y.- J. Choi, “Experimental study of internal reforming on large-area anode supported solid oxide fuel cells,” Fuel Cells, DOI: 10.1002/fuce.201400070.
[6] Ö. Aydin, H. Nakajima, and T. Kitahara, “Current and temperature distributions in situ acquired by electrode-segmentation along a microtubular solid oxide fuel cell operating with syngas,” J. Power Sources, 293, 1053 (2015).
[7] K. Sasaki and Y. Teraoka, “Equilibria in fuel cell gases I. Equilibrium compositions and reforming conditions” Journal of The Electrochemical Society, 150, 7, A878-A884 (2003).
[8] R. Kikuchi and K. Eguchi, “Solid oxide fuel cell as a multi-fuel applicable power generation device”, Journal of the Japan Petroleum Institute, 47, 4, 225-238 (2004)
[9] A. Selimovic, M. Kemm, T. Torisson, and M. Assadi, “Steady state and transient stress analysis in planar solid oxide fuel cells,” J. Power Sources, 145, 463 (2005)
[10] A. Nakajo, C. Stiller, G. Härkegård, and O. Bolland, “Modelling of thermal stresses and probability of survival of tubular SOFC,” J. Power Sources, 158, 287 (2006).
[11] C. M. Dikwal, W. Bujalski, and K. Kendall, “The effect of temperature gradients on thermal cycling and isothermal ageing of micro-tubular solid oxide fuel cells,” J. Power Sources, 193, 241 (2009).
[12] C.- K. Lin, T.- T. Chen, Y.- P. Chyou, and L.- K. Chiang, “Thermal stress analysis of a planar SOFC stack,” J. Power Sources, 164, 238 (2007).
[13] L.- K. Chiang, H.- C. Liu, Y.- H. Shiu, C.- H. Lee, and R.- Y. Lee, “Thermoelectrochemical and thermal stress analysis for an anode-supported SOFC cell,” Renewable Energy, 33, 2580 (2008).
[14] K. Fischer and J. R. Seume, “Impact of the temperature profile on thermal stress in a tubular solid oxide fuel cell,” J. Fuel Cell Sci. Technol., 6, 011017 (2009).
[15] C. M. Finnerty, N. J. Coe, R. H. Cunningham, and R. Mark Ormerod, “Carbon formation on and deactivation of nickel-based/zirconia anodes in solid oxide fuel cells running on methane,” Catalysis Today, 46, 137-145 (1998).
[16] E. N. Fuller, P. D. Schettler, and J. C. Giddings. “A new method for prediction of binary gas-phase diffusion coefficients,” Ind Eng Chem, 58, 18-27 (1966).
[17] P. A. Lessing et al., inventor, Lockheed Idaho Technologies Company, assignee. “Catalytic bipolar interconnection plate for use in a fuel cell,” U.S. Pat. No. 5,496,655. Mar. 5, 1996.
[18] M. Farooque et al., inventor; Energy Research Corporation, assignee. “Catalyst assembly for internal reforming fuel cell,” U.S. Pat. No. 5,660,941. Aug. 26, 1997.
[19] D.- J. Liu et al., inventor; General Electric Company, assignee. “Solid oxide fuel cell with internal reforming, catalyzed interconnect for use therewith, and methods,” U.S. Pat. No. 7,732,084 B2. Jun. 8, 2010.
[20] S. Blanchet et al., inventor. “Corrugated current collector for direct internal reforming fuel cells,” US patent 2002/0197518 A1. Dec. 26, 2002.
[21] E. E. Paz et al., “Solid oxide fuel cell interconnect with catalyst coating,” US patent 2005/0053819 A1. Mar. 10, 2005.
[22] M. Matsumara et al., inventor; Mitsubishi Denki Kabushiki Kaisha, assignee. “Internal reforming type fuel cell,” U.S. Pat. No. 4,647,516. Mar. 3, 1987.
[23] R. Bernard, inventor; Energy Research Corporation, assignee. “Fuel cell with partially shielded internal converter,” U.S. Pat. No. 4,788,110. Nov. 29, 1998.
[24] A. T. Crumm et al., Adaptive Materials Inc., assignee. “Solid oxide fuel cell tube with internal fuel processing,” U.S. Pat. No. 7,547,484 B2. Jun. 16, 2009.
[25] C. Brown et al., inventor; Versa Power Systems, Ltd, assignee. “Deactivation of SOFC anode substrate for direct internal reforming,” U.S. Pat. No. 8,216,738 B2. Jul. 10, 2012.
[26] B. S. Baker et al., inventor; Energy Research Corporation, assignee. “Fuel cell thermal control and reforming of process gas hydrocarbons,” U.S. Pat. No. 4,182,795. Jan. 8, 1980.
[27] H. C. Maru et al., inventor; Energy Research Corporation, assignee. “Fuel cell with internal reforming,” U.S. Pat. No. 4,365,007. Dec. 21, 1982.
[28] P. Patel et al., inventor; Energy Research Corporation, assignee. “Fuel cell employing non-uniform catalyst,” U.S. Pat. No. 4,567,117. Jan. 28, 1986.
[29] B. S. Baker, inventor; Energy Research Corporation, assignee. “Fuel cell apparatus for internal reforming,” U.S. Pat. No. 4,877,693. Oct. 31, 1989.
[30] P. Reichner, inventor; Westinghouse Electric Corp., assignee. “Internal natural gas converter-dividers for a solid oxide fuel cell generator configuration,” U.S. Pat. No. 5,082,751. Jan. 21, 1992.
[31] M. Z. Khan, R.- H. Song, A. Hussain, S.- B. Lee, T.- H. Lim, J.- E. Hong, “Effect of applied current density on the degradation behavior of anode-supported flat-tubular solid oxide fuel cells,” Journal of the European Ceramic Society, 40, 4, 1407-1417 (2020)

1. A DIR-SOFC system by comprising: a fuel pipe, a head flange, a DIR tube, an EHO tube, a DIR end flange, a last flange, a DIR exhaust pipe, an EHO exhaust pipe, connecting bolts, and ceramic paste.

2. The DIR-SOFC system according to claim 1, wherein a diameter of the EHO tube is larger than a diameter of the DIR tube to maximize the utilization rate of all hydrogen produced in the DIR tube.

3. The DIR-SOFC system according to claim 1, wherein the DIR tube has a microstructure that can prevent the diffusion of methane and water towards the EHO tube.

4. The DIR-KO fuel cell system according to claim 1, wherein an anode wire and/or a cathode wire is made of metal or non-metal material with high conductivity.

5. The DIR-KO fuel cell system according to claim 1, wherein the EHO tube has at least three layers: anode, cathode and electrolyte.
